(19) United States
(12) Patent Application Publication
(10) Pub. No.: US 2022/0256833 A1
(43) Pub. Date: Aug. 18, 2022

(54) ROBOTIC WEED CONTROL APPARATUS AND METHOD

(71) Applicant: Greenfield Robotics Corporation, Cheney, KS (US)

(72) Inventors: Clinton W. Brauer, Cheney, KS (US); Royce A. Steinert, Hutchinson, KS (US)

(73) Assignee: Greenfield Robotics Corporation, Cheney, KS (US)

(21) Appl. No.: 17/735,445

(22) Filed: May 3, 2022

Related U.S. Application Data
(63) Continuation-in-part of application No. PCT/US2021/055818, filed on Oct. 20, 2021.
(60) Provisional application No. 63/104,798, filed on Oct. 23, 2020.

(51) Int. Cl. A01M 21/02; A01D 34/835; A01D 34/416; A01D 34/83; A01D 34/52; A01D 34/54

(52) U.S. Cl. CPC A01M 21/02; A01D 34/835; A01D 34/54; A01D 34/83; A01D 34/52; A01D 34/416

(57) ABSTRACT

An apparatus for weed removal includes a chassis and at least two end effectors mechanically coupled to the chassis, each end effectors including a rotary axle, each rotary axle coupled to a drive unit for receiving a mechanical force to cause the rotary axle to rotate. The rotary axles, along with weed abrasion members coupled thereto, are at least partially covered by a deflector. A front end effector is configured to dislodge a crown and/or stem portion of unwanted plant material from the ground, while another end effector is configured to convert the unwanted plant material that has been dislodged from the ground into mulch.

### CROSS-REFERENCE TO RELATED APPLICATIONS

This application is a continuation-in-part of International Patent Application No. PCT/US2021/055818, filed Oct. 20, 2021, which claims the benefit of U.S. Provisional Patent Application No. 63/104,798, filed Oct. 23, 2020, all of which are hereby incorporated by reference in their entirety.

### BACKGROUND

This disclosure generally relates to control of weeds in farming operations, and more specifically to a system and process for the removal and prevention of weed growth using a robotic weed control system.

Weed control is difficult to accomplish in broadacre farming. Tilling the soil is expensive, time consuming, results in erosion, and can negatively affect soil quality. Farm operations that till still require additional herbicides which may be organic certified or chemical. For “no-till farming,” meaning the farmer does not till the soil. Typically, this means the farm is dependent entirely on herbicides for weed control. Conventional no-till farming refers to a system of farming that consists of planting a narrow slit trench without tillage and with the use of herbicides to suppress weeds.

In organic farming operations, particularly organic no-till farming operations, weed control is particularly challenging as organic herbicides don't work very well. Moreover, chemical risk rates are rising alongside the costs of chemical controls, and efficacy of the chemicals is being challenged through constantly mutating weed resistance. The removal or control of weed growth without the use of herbicides is becoming more of a necessity.

Conventional approaches, however, such as manual labor, can be very time consuming and expensive, and for large farming operations prohibitively so, making these approaches not practical. Currently available automated robotic systems for weed control are limited to broad-leaf weeds that can be controlled with mowing-type operations, which cut leaves and temporarily slow the growth of the weed. However, these systems do not effectively control grass-like weeds, which are not significantly impacted by the mowing-type operations.

Thus, what is needed is a robotic weed control apparatus that addresses the deficiencies of the prior art and the needs of the no-till farmer.

### BRIEF SUMMARY

According to various embodiments of the present invention, a method and apparatus are provided for the control of unwanted plant material, including dislodging said unwanted plant material from the ground. An apparatus for control of unwanted plant material may include: a chassis; and two or more end effectors mechanically coupled to the chassis, the two or more end effectors including a first end effector comprising a first rotary axle and a second end effector comprising a second rotary axle, each of the first and second rotary axles coupled to a drive unit for receiving a mechanical force to cause the rotary axle to rotate, wherein the first end effector comprises a first deflector at least partially covering the first rotary axle and a first plurality of weed abrasion members removably coupled to the first rotary axle in a first radial pattern, and wherein the second end effector comprises a second deflector at least partially covering the second rotary axle and a second plurality of weed abrasion members removably coupled to the second rotary axle in a second radial pattern. In some examples, the first end effector is configured to dislodge one or both of a crown portion and a stem portion of the unwanted plant material from the ground. In some examples, the second end effector is configured to convert at least some of the unwanted plant material into mulch. In some examples, the apparatus also includes a baffle comprising a front edge extending into the first end effector. In some examples, the baffle further comprises a back edge positioned higher than the front edge. In some examples, the apparatus also includes a hinged flap coupled to a back end of the second deflector. In some examples, one or both of the first and the second rotary axles are height adjustable. In some examples, one or both of the first and second plurality of weed abrasion members comprise(s) a filament, a chain, a blade, or a disc. In some examples, the first plurality of weed abrasion members comprises a different form than the second plurality of weed abrasion members. In some examples, the first end effector is coupled to the chassis at a height such that the first plurality of weed abrasion members are caused to disturb between 0.125 and 0.25 inches of a top layer of soil when the first rotary axle is turning. In some examples, the second plurality of weed abrasion members are longer than the first plurality of weed abrasion members. In some examples, the chassis is constructed of one, or a combination, of aluminum, steel, and carbon fiber. In some examples, the chassis is configured to carry the drive unit. In some examples, the chassis is configured to carry a power source.

In some examples, the apparatus also includes a controller configured to provide control of one or more components of the chassis and/or the end effector. In some examples, the one or more components includes one, or a combination, of a drive train module, a power source, and the end effector. In some examples, the controller includes a sensing module configured to process data from one or more sensors.

A method may include: disturbing a top portion of soil using a first plurality of abrasion members of a first end effector, thereby dislodging at least a portion of an unwanted plant material from a ground; converting the at least the portion of the unwanted plant material into mulch using a second plurality of abrasion members of a second end effector; and depositing the mulch back onto the ground, at least in part by a rotational motion of the second plurality of abrasion members within a deflector of the second end effector. In some examples, the at least a portion of the unwanted plant material comprises one or both of a crown portion and a stem portion of the unwanted plant material. In some examples, the method also includes depositing the portion of the unwanted plant material back onto the ground after dislodging the at least the portion of the unwanted plant material from the ground with the aid of a baffle comprising a front edge extending into the first end effector. In some examples, the first end effector is positioned in front of the second end effector relative to a forward motion of a chassis to which the first and the second end effectors are coupled. In some examples, the top portion of soil comprises between 0.125 and 0.25 inches of a top layer of the soil. In some examples, the disturbing the top portion of soil is no-till compliant.

### BRIEF DESCRIPTION OF THE SEVERAL VIEWS OF THE DRAWINGS

FIG. 1 illustrates an exemplary weed control robotic apparatus according to one embodiment of the disclosure.

FIG. 2 illustrates another exemplary weed control robotic apparatus according to one embodiment of the disclosure.

FIG. 3A is a diagram that illustrates an isometric view of components of an exemplary end effector for weed control robotic apparatus according to one or more embodiments of the disclosure.

FIG. 3B is a diagram that illustrates a different view of the components of the exemplary end effector for weed control robotic apparatus of FIG. 3A.

FIG. 3C is a diagram that illustrates a different view of the components of the exemplary end effector for weed control robotic apparatus of FIG. 3A.

FIG. 4A is a diagram that illustrates an isometric view of components of an exemplary end effector for weed control robotic apparatus according to one or more embodiments of the disclosure.

FIG. 4B is a diagram that illustrates a different view of the components of the exemplary end effector for weed control robotic apparatus of FIG. 4A.

FIG. 4C is a diagram that illustrates a different view of the components of the exemplary end effector for weed control robotic apparatus of FIG. 4A.

FIG. 5A is a diagram that illustrates an isometric view of components of an exemplary end effector for weed control robotic apparatus according to one or more embodiments of the disclosure.

FIG. 5B is a diagram that illustrates a different view of the components of the exemplary end effector for weed control robotic apparatus of FIG. 5A.

FIG. 5C is a diagram that illustrates a different view of the components of the exemplary end effector for weed control robotic apparatus of FIG. 5A.

FIG. 6A is a diagram that illustrates an isometric view of components of an exemplary end effector for weed control robotic apparatus according to one or more embodiments of the disclosure.

FIG. 6B is a diagram that illustrates a different view of the components of the exemplary end effector for weed control robotic apparatus of FIG. 6A.

FIG. 6C is a diagram that illustrates a different view of the components of the exemplary end effector for weed control robotic apparatus of FIG. 6A.

FIG. 7 illustrates still another exemplary weed control robotic apparatus according to one or more embodiments of the disclosure.

FIG. 8 is a flow diagram illustrating a method for robotic weed control, in accordance with one or more embodiments of the disclosure.

FIGS. 9A-9B are diagrams that illustrate perspective views of other exemplary end effectors for weed control robotic apparatus according to one or more embodiments of the disclosure.

FIG. 10 is a flow diagram illustrating another method for robotic weed control, in accordance with one or more embodiments of the disclosure.

The figures depict various example embodiments of the present disclosure for purposes of illustration only. One of ordinary skill in the art will readily recognize form the following discussion that other example embodiments based on alternative structures and methods may be implemented without departing from the principles of this disclosure and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures. The above and other needs are met by the disclosed methods and systems for automated robotic control of weeds.

The techniques described herein provide for targeted and efficient weed control, wherein weed plants may be effectively removed while carbon remains sequestered in the ground. Hereinafter, the terms “weed plant(s)” and “unwanted plant material” will be used interchangeably to include weed plants, unwanted cover crops, and other unwanted plants and plant material. Rather than merely stunting weeds or other above-ground plant material (e.g., cutting above ground, pushing down, crimping and breaking plants, as achieved by mowing, roller-crimping, and other conventional techniques), the autonomous or driven apparatuses described herein remove or dislodge the crowns and/or remove the stem of unwanted plant material (e.g., weed plants, cover crops, other plant species, large or small) for more effective and longer-lasting weed elimination or control. This is achieved by disturbing a top portion of the soil (e.g., 0.1-0.3 inches, or slightly more or less, without disrupting the soil structure), just deep enough to remove (i.e., dislodge) the crowns and/or stems of weed plants and other unwanted plant material from the ground, using abrasion members (e.g., filaments, blades, chains, discs, and other forms, as described and shown herein), without disturbing the soil structure and the roots therein. As weed plants and a top portion of the soil is removed, it is turned into mulch and laid back down by an end effector (e.g., comprising an axle rotating or otherwise driving abrasion members to disturb and remove weed plants, turning it into mulch as it passes under the deflector and back onto the ground). The mulch works to suppress regrowth of weeds (e.g., blocking their access to sunlight), as well as breaking the fall of rain while allowing the rainwater to soak into the soil. In some examples, this method may be no-till compliant.

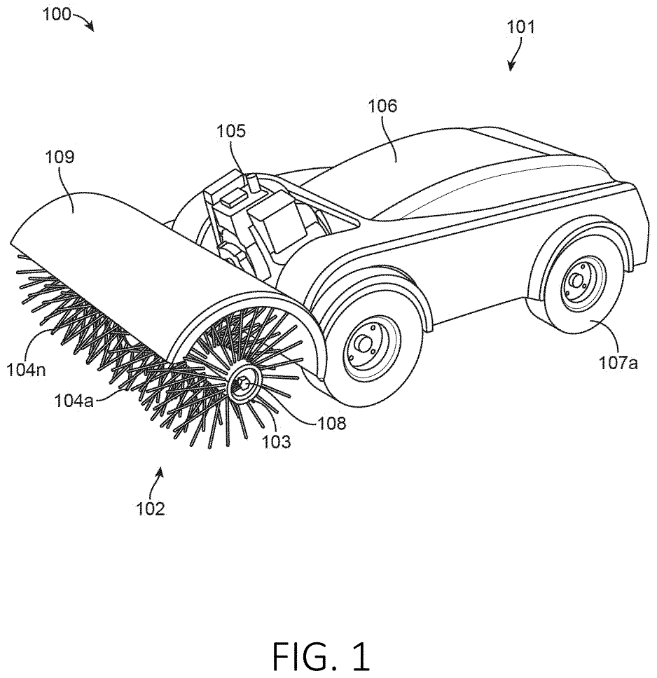

Referring now to FIG. 1, an isometric view of an exemplary weed control robotic apparatus according to embodiments is illustrated. The weed control robotic apparatus 100 includes a robotic chassis 101 and an end effector 102. The robotic chassis 101 according to one embodiment includes a drive train module 106 to provide mobility to the apparatus 100. In this embodiment, the drive train module 106 includes four wheels 107a-107d (not all are shown) driven by a motor (not shown).

The end effector 102 includes a rotary axle 103 mechanically coupled to a drive unit 105 and a deflector 109 that surrounds an upper section of the end effector 102. The drive unit may include a motor, such as an electric motor, a gas engine, or the like. The rotary axle 103 may be a generally cylindrical tube made of a durable material, such as metal, hard plastic, carbon fiber, or the like. According to an aspect of some embodiments, the end effector 102 is cantilevered from the robotic chassis 101 but other attachment geometries may be used in different embodiments. The cantilevered end effector design can be used to make switching weed abrasion members or cutting heads easier, for example. In some embodiments, an outboard support to the rotary axle 103 (not shown) may be provided in cantilevered designs for additional stability. The outboard support may be removable to facilitate the change of weed abrasion members. In other embodiments, a longer rotary axle 103 can be provided and it may be supported on both ends of the axle.

In the embodiment illustrated in FIG. 1, the rotary axle 103 has a cylindrical shape. However, in other embodiments, differently-shaped rotary axles 103 may be used, with profiles that instead of circular shapes may include different shapes, such as for example, square, hexagonal, octagonal, or the like. Along the outside diameter of the rotary axle 103, a set of radially spaced weed abrasion members 104a-104n protrude outwardly in a radial direction away from the outer surface of the rotary axle. For example, in one embodiment, the weed abrasion members may include weed removing filaments. The filaments can vary in length, material and design of the radial pattern or in the form of metal or plastic. In other examples, weed abrasion members 104a-104n may comprise blades, chains, discs, and other forms, as described and shown herein. The filaments 104 are removably attached to a core rod 108 that runs axially through the center of the rotary axle 103. The drive unit 105 engages the rotary axle 103 through a drive shaft (not shown) to cause the rotary axle's rotation around its long axis, causing the outer end of the filaments 104 to contact the ground under the apparatus 100 to disturb vegetation directly under the end effector with minimal soil disturbance. The system 100 may be controlled using a combination of machine vision based on-field characteristics and combined with other control systems (e.g., GPS and/or Lidar combined with drone imaging or maps data to create 3D imaging), for example, to assist with controlling the height of the axle platform.

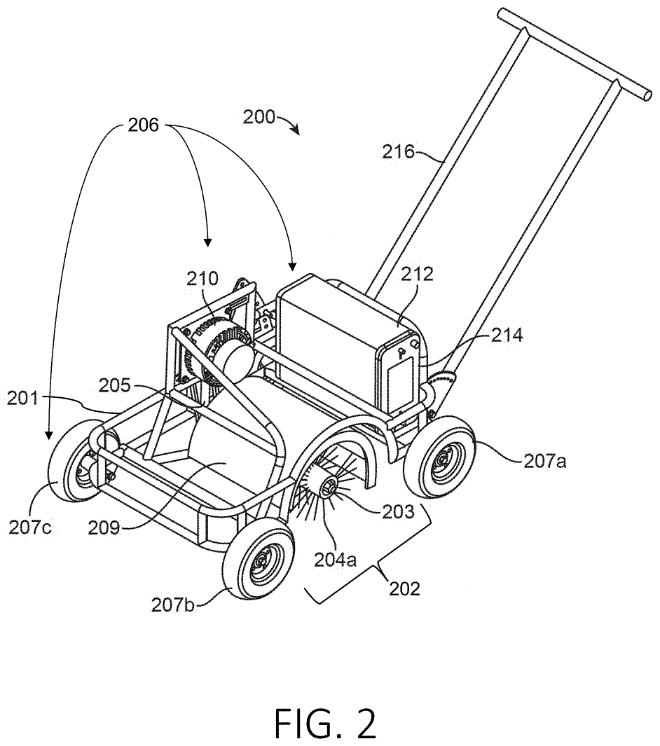

Now referring to FIG. 2, an isometric view of another exemplary weed control robotic apparatus according to embodiments is illustrated. The weed control robotic apparatus 200 includes a robotic chassis 201 and an end effector 202. The robotic chassis 201 according to one embodiment includes a drive train module 206 to provide mobility to the apparatus 200. In this embodiment, the drive train module 206 includes four wheels 207a-207d (not all are shown) driven by a motor 210. The chassis 201 in some embodiments may be constructed of a light-weight but durable and strong material, such as aluminum, steel, carbon fiber, or the like. The chassis 201 is designed to be strong enough to support the weight of the components of the robotic apparatus 200, the vibrations that may be generated during operation, and for durability in farming operations. However, given the autonomous operation of the robotic apparatus 200, light-weight materials beneficially extend the operational time, fuel, or battery power of the system, depending on the embodiment.

In some embodiments, the drive train module 206 may include a motor 210 to drive all wheels, such as for example, an electric motor, a gas engine, or the like. In some embodiment, each wheel 207 may include an electric motor or driver or each axle with a pair of wheels 207, or one such axle, may include an electric motor. One of ordinary skill in the art would understand that the choice of the power train for the robotic apparatus 200 is a matter of design choice and optimization. In embodiments using electric motors, as for example illustrated in FIG. 2, a battery or set of battery cells 212 may be provided to power the electric motor 210. In some embodiments, robotic system 200 may also include a removable handle 216 to facilitate the handling of the system by human operators, for example, to load or unload into a vehicle, for testing, and the like.

A controller 214 may also be included to provide control of the robotic apparatus 200, including maneuvering of the drive train module, battery management, end effector control, communications, and the like. In embodiments, controller 214 may include a sensing module, a communications module, a memory module, and a processing module. Sensing module (not shown) may include one or more sensors, including, for example, one or more cameras, multi-axle accelerometers, gyroscopes, depth sensing cameras, lidar, piezo-electric sensors, laser-based sensors, light sensors, temperature sensors, relay sensors, and the like. Sensors that make up a sensor module may be distributed across the robotic apparatus 200 to provide optimal sensing functionality. A communications module (not shown) may include wired and wireless communications hardware and software. For example, serial computer interface connections may be supported, such as USB, as well as wireless connections, such as Bluetooth, Wi-Fi, cellular, Global Positioning System (GPS), or the like. The communications module can include radio frequency hardware and software, including antennas, modulators/demodulators, amplifiers, baseband processors, and the like, designed and programmed to receive and transmit signals according to any number of wireless protocols. In some examples, controller 214 may include a processing module, along with a memory module, provide for computing capabilities according to programming software and/or firmware that may be stored in computer readable media, such as RAM or ROM memory (e.g., FLASH), hard drives, or the like. Processing module may include any type of processor system capable of executing computer instructions and interfaced to parallel and/or serial ports for controlling the operation of the robotic apparatus 200. The controller 214 may include any number of application-specific controlling modules under the control of a processing module for controlling different functions of the robotic apparatus 200, including for example, camera sub-systems, servo-control systems, battery charging systems, and the like.

In embodiments, controller 214 may include operational controls to manage the operation of the robotic apparatus 200, including a user interface allowing local and/or remote control operations from a user. For example, a user may program controller 214, or a set of controllers 214 in multiple systems 200, to cooperatively process one or more fields in a farm for weed control operations. For example, in some embodiments, multiple robotic apparatus 200 can communicate with each other via wireless computer networks, including ad hoc, mesh, and peer-to-peer networks for example. According to some embodiments, controller 214 includes machine vision functionality using cameras and sensors (not shown). Controller 214 uses these sensors to determine field characteristics and receives remote signals, such as GPS signals, drone signals, or the like, for example to create 3D imaging for autonomously maneuvering the apparatus through the farm fields. Controller 214 may also include on-board memory and/or other storage to store and access map data for maneuvering and to assist with the height of the axle platform, for example. According to embodiments, different sets of parameters can be adjusted based on the terrain and type of weed being removed. For example, pre-selected parameters, such as rotational speed, forward speed, blade/disc angle (if applicable), and the like may be pre-programmed into weed abatement “recipes” for particular types of weeds. These recipes may be programmed into controller 214, remotely changed, and/or automatically changed by controller 214 upon detection of changes in weed type being processed, for example, based on machine vision, location-based pre-programmed zones, or the like.

The end effector 202 includes a rotary axle 203 mechanically coupled to a drive unit 205 and a deflector 209 that surrounds at least an upper section of the end effector 202. In embodiments, the drive unit 205 may include a gear box (not shown) to derive rotational power from the motor 210 in the drive train module 206. For example, interchangeable pulley sizes and mechanical shifting gears may be provided to accurately control the rotational speed of the end effector. However, in different embodiments, a separate motor may be used. The rotary axle 203 may be a generally cylindrical tube made of a durable material, such as metal, hard plastic, carbon fiber, or the like. According to an aspect of some embodiments, the end effector 202 is positioned in the middle of the robotic chassis 201 but other attachment geometries may be used in different embodiments. In addition, in embodiments, the end effector mounting to the chassis is automatically adjustable to vary the distance or height between the rotary axle and the ground. For example, controller 214 may adjust the height of the end effector according to terrain sensors to account for changes in the terrain under the robotic apparatus 200. Moreover, machine vision may be used to identify changes in the type of weed being removed, allowing the controller 214 to adjust height, rotational speed, forward speed, and other parameters.

In the embodiment illustrated in FIG. 2, along the outside diameter of the rotary axle 203, a set of radially spaced weed abrasion members 204a-204n protrude outwardly in a radial direction away from the outer surface of the rotary axle. For example, in one embodiment, the weed abrasion members 204 may include weed removing filaments. The filaments can vary in length, material and design of the radial pattern or in the form of metal or plastic. The filaments 204 may be removably attached to a core rod that runs axially through the center of the rotary axle 203. The drive unit 205 engages the rotary axle 203 through a drive shaft (not shown) to cause the rotary axle's rotation around its long axis, causing the outer end of the filaments 204 to contact the ground under the apparatus 200 to disturb vegetation directly under the end effector with minimal soil disturbance.

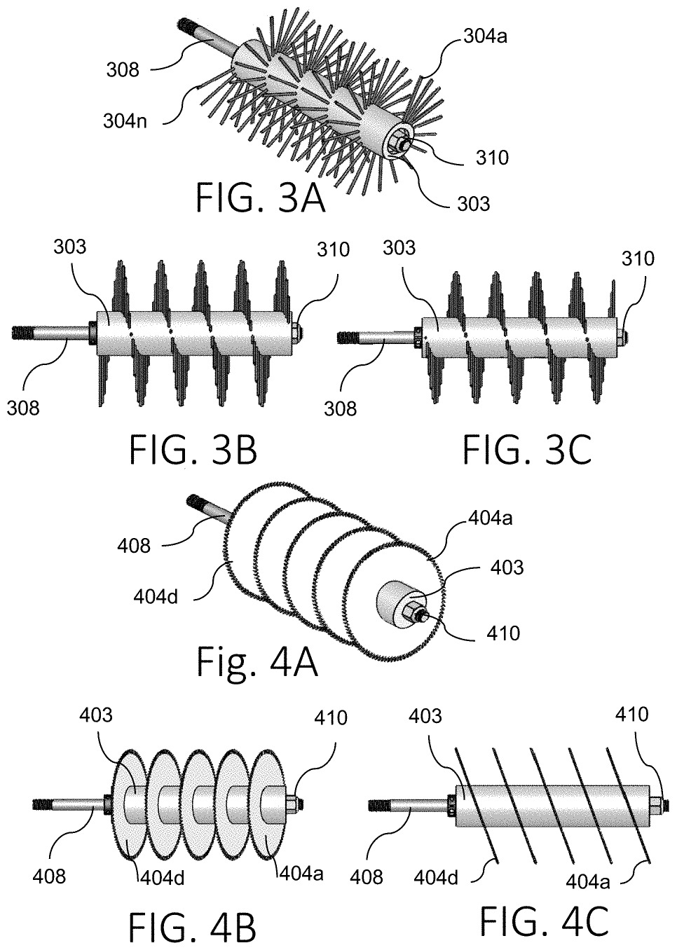

Now referring to FIG. 3A, an illustrative diagram of an isometric view of one embodiment of components of an end effector is provided. In this embodiment, the end effector includes a rotary axle 303. In this embodiment, the rotary axle 303 has a cylindrical shape. However, in other embodiments, differently-shaped rotary axles 303 may be used, with profiles that instead of circular shapes may include different shapes, such as for example, square, hexagonal, octagonal, or the like. Along the outside diameter of the rotary axle 303, a set of radially spaced weed abrasion members 304a-304n protrude outwardly in a radial direction away from the outer surface of the rotary axle 303. In this embodiment, the weed abrasion members 304 include weed removing filaments. The filaments can vary in length, material and design of the radial pattern or in the form of metal or plastic. The filaments 304 are removably attached to a core rod 308 that runs axially through the center of the rotary axle 303 and is mechanically secured to the rotary axle 303 with a nut 310.

In one embodiment, a rotary axle 303 is between 3 and 30 inches in length. However, in other embodiments the rotary axle 303 may be of any size as long as it can be driven by a drive unit. For example, the length of the rotary axle 303 may be selected to fit between rows of planted crops in a field to disturb substantially the entire perpendicular distance between the rows of crops with each pass. The filaments 304 may be made of nylon or other suitable material, allowing some flexibility for the ends of the filaments to bend upon contact with the ground or plant materials but with sufficient rigidity to provide enough friction for removal of the plant material upon rotational contact.

FIG. 3B and FIG. 3C illustrate different views of the end effector components of FIG. 3A. As more clearly illustrated in these figures, the filaments 304 protrude from the cylindrical axle 303 following a spiral pattern axially along the length of the axle 303 or shaft.

Now referring to FIG. 4A, an illustrative diagram of an isometric view of one embodiment of components of an end effector is provided. In this embodiment, the end effector includes a rotary axle 403. In this embodiment, the rotary axle 403 has a cylindrical shape. However, in other embodiments, differently-shaped rotary axles 403 may be used, with profiles that instead of circular shapes may include different shapes, such as for example, square, hexagonal, octagonal, or the like. In this embodiment, the walls of the cylindrical rotary axle 403 are thicker than those of the rotary axle of FIG. 3A, allowing for a stronger axle construction, for example, if using the same material. Extending from the outside diameter of the rotary axle 403, in a radial direction away from the outer surface of the rotary axle 403, a set of spaced weed abrasion members 404a-404d is provided. In this embodiment, 5 weed abrasion members 404a-404d are provided but in different embodiments a different number of members 404n can be provided. In this embodiment, weed abrasion members 404 are weed removing discs. The discs 404 can vary in diameter, material and position with respect to the axle 403. Weed removing discs 404 may be made of metal or plastic. The discs 404 may be removably attached to the rotary axle 403. For example, rotary axle 403 may be divided into a plurality of cylindrical members disposed between each disc 404, mechanically attaching each disc to the axle. For example, each cylindrical member may include two or more pins on one side and two or more holes on the other side to receive the pins from the next member. The pins can protrude through holes in an inner diameter of each disc 404, securing each disc in place and allowing for rotational force to transfer from the axle to the discs. The first member may only include holes while the last member may only include pins that secure disc 404a in place and the entire assembly is mechanically secured to the rotary axle 403 with a nut 410.

In one embodiment, a rotary axle 403 is between 3 and 30 inches in length. However, in other embodiments the rotary axle 403 may be of any size as long as it can be driven by a drive unit. For example, the length of the rotary axle 403 may be selected to fit between rows of planted crops in a field to disturb substantially the entire perpendicular distance between the rows of crops with each pass. The discs 404 may be made of steel, carbon fiber, or other suitable material, allowing limited flexibility at the ends of the discs to bend upon contact with the ground or plant materials but with sufficient rigidity to provide enough friction for removal of the plant material upon rotational contact. Similarly, the desired flexibility and/or stiffness can be achieved through material selection and/or disc thickness, which may be different for different applications. As illustrated in FIG. 4A, the edge of the discs 404 may be serrated but not necessarily. In some embodiments, non-serrated discs may be provided, depending on the intended weeding application.

FIG. 4B and FIG. 4C illustrate different views of the end effector components of FIG. 4A. As more clearly illustrated in these figures, the discs 404 can be placed at different angles with respect to the longitudinal axis of the cylindrical axle 403. For example, as illustrated in FIG. 4C, the discs 404 may be placed at an angle of between 75 and 85 degrees from the outer surface of the rotary axle 403. However, in some embodiments the discs 404 may be perpendicularly disposed (at 90 degrees). The angle at which the discs may be disposed can be selected depending on the weeding application, including types of weeds, terrain, ground composition, and the like. For example, angled discs may present a broader surface contact with the weeds and/or ground, which may be desirable for some weeding applications. In some embodiments, the disc angle may be dynamically changed during operation, for example via a mechanical lever system controlled by an on-board controller.

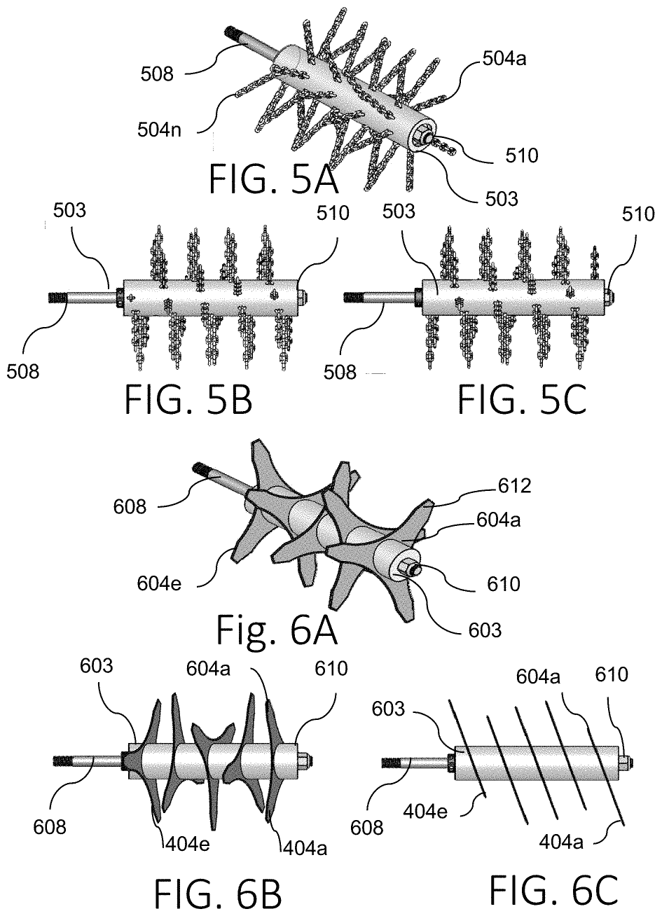

Now referring to FIG. 5A, an illustrative diagram of an isometric view of one embodiment of components of an end effector is provided. In this embodiment, the end effector includes a rotary axle 503. In this embodiment, the rotary axle 503 has a cylindrical shape. However, in other embodiments, differently-shaped rotary axles 503 may be used, with profiles that instead of circular shapes may include different shapes, such as for example, square, hexagonal, octagonal, or the like. Along the outside diameter of the rotary axle 503, a set of radially spaced weed abrasion members 504a-504n protrude outwardly in a radial direction away from the outer surface of the rotary axle 503. In this embodiment, the weed abrasion members 504 include weed removing chains. The weed removing chains can vary in length, material and design of the radial pattern. The weed removing chains 504 may be composed of chain links of different sizes, including the overall diameter of each chain link, the thickness of the chain link material, and the type of material used. The chain links 504 may be removably attached to a core rod 508 that runs axially through the center of the rotary axle 503 and is mechanically secured to the rotary axle 503 with a nut 510.

In one embodiment, a rotary axle 503 is between 3 and 30 inches in length. However, in other embodiments the rotary axle 503 may be of any size as long as it can be driven by a drive unit. For example, the length of the rotary axle 503 may be selected to fit between rows of planted crops in a field to disturb substantially the entire perpendicular distance between the rows of crops with each pass. The chains 504 may be made of metal or other suitable material. The chain construction allows some flexibility for the ends of the chains to bend upon contact with the ground or plant materials but, while spinning, they provide sufficient rigidity to provide enough friction for removal of the plant material upon rotational contact.

FIG. 5B and FIG. 5C illustrate different views of the end effector components of FIG. 5A. As more clearly illustrated in these figures, the chains 504 protrude from the cylindrical axle 503 following a spiral pattern axially along the length of the axle 503 or shaft.

Now referring to FIG. 6A, an illustrative diagram of an isometric view of one embodiment of components of an end effector is provided. In this embodiment, the end effector includes a rotary axle 603. In this embodiment, the rotary axle 603 has a cylindrical shape. However, in other embodiments, differently-shaped rotary axles 603 may be used, with profiles that instead of circular shapes may include different shapes, such as for example, square, hexagonal, octagonal, or the like. In this embodiment, the walls of the cylindrical rotary axle 603 are thicker than those of the rotary axle of FIG. 3A, allowing for a stronger axle construction, for example, if using the same material. Extending from the outside diameter of the rotary axle 603, in a radial direction away from the outer surface of the rotary axle 603, a set of spaced weed abrasion members 604a-604e is provided. In this embodiment, 6 weed abrasion members 604a-604e are provided but in different embodiments a different number of members 604n can be provided. In this embodiment, weed abrasion members 604 are multi-prong weed removing blades. The blades 604 can vary in diameter, number of prongs, material and position with respect to the axle 603. Weed removing blades 604 may be made of metal or plastic and, while in the embodiment shown each multi-prong blades include three prongs 612 (sometimes referred to as “knives”), any number of prongs may be feasibly provided. Moreover, the prong 612 geometries may vary in different embodiments. For example, a blunt-tip arrow shape is illustrated in the prongs 612 of FIG. 6A, but round-tip, or arrow-tip shapes may be used. Moreover, entirely different tip shapes, such as half-circles, points, straight edge, serrated edge, or the like may be provided in different embodiments.

The blades 604 may be removably attached to the rotary axle 603. For example, rotary axle 603 may be divided into a plurality of cylindrical members disposed between each blade 604, mechanically attaching each blade to the axle. For example, each cylindrical member may include two or more pins on one side and two or more holes on the other side to receive the pins from the next member. The pins can protrude through holes in an inner diameter of each blade 604, securing each blade in place and allowing for rotational force to transfer from the axle to the blades. The first member may only include holes while the last member may only include pins that secure blade 604a in place and the entire assembly is mechanically secured to the rotary axle 603 with a nut 610. It should be noted that in some embodiments different types of weed abrasion members can be interchangeably provided for the end user to use different types of weed abrasion members with the same system, depending on the intended weeding application. For example, discs 404 and blades 604 can be designed to be interchangeable with each other.

In one embodiment, a rotary axle 603 is between 3 and 30 inches in length. However, in other embodiments the rotary axle 603 may be of any size as long as it can be driven by a drive unit. For example, the length of the rotary axle 603 may be selected to fit between rows of planted crops in a field to disturb substantially the entire perpendicular distance between the rows of crops with each pass. The blades 604 may be made of steel, carbon fiber, or other suitable material, allowing limited flexibility at the ends of the blade prongs 612 to bend upon contact with the ground or plant materials but with sufficient rigidity to provide enough friction for removal of the plant material upon rotational contact. Similarly, the desired flexibility and/or stiffness can be achieved through material selection and/or blade thickness, which may be different for different applications.

FIG. 6B and FIG. 6C illustrate different views of the end effector components of FIG. 6A. As more clearly illustrated in these figures, the blades 604 can be placed at different angles with respect to the longitudinal axis of the rotary axle 603. For example, as illustrated in FIG. 6C, the blades 604 may be placed at an angle of between 75 and 85 degrees from the outer surface of the rotary axle 603. However, in some embodiments the blades 604 may be perpendicularly disposed (at 90 degrees). The angle at which the blades may be disposed can be selected depending on the weeding application, including types of weeds, terrain, ground composition, and the like. For example, angled blades may present a broader surface contact with the weeds and/or ground, which may be desirable for some weeding applications. In some embodiments, the blade angle may be dynamically changed during operation, for example via a mechanical lever system controlled by an on-board controller.

In operation, the end effector's rotary axle rotates at a sufficient speed causing the end of the weed abrasion elements to scrape the ground under the rotary axle and remove any weed or other plant material by friction. The rotary axle rotates causing the weed abrasion elements to spin at a desired and controlled speed upwards of 15,000 feet per second at the tip of the weed abrasion member. For example, in surface feet per minute at the edge or tip of the weed abrasion member (“sfpm”), the following are exemplary speeds for operation of different weed abrasion members:

For a 10-inch discs≈7100 sfpm

For a 9-inch 3-prong blades≈6800 sfpm

For a 10-inch chain≈6800 sfpm

For 9-inch nylon filaments≈6400 sfpm

For 12-inch nylon filaments≈8500 sfpm

It should be noted that excessive speed can substantially increase the friction between the weed abrasion members and the ground, possibly causing dry plant material to combust into a fire. Thus, control of the rotational speed for the given type of weed abrasion member and for a given application is provided, for example, via programmable settings in a controller module. For example, for knocking down a cover crop that is still growing, the mechanism may run slower but with more power. But for cleanup of light weeds on the surface, different speed/different power may be used.

Upon contact with plant material, the weed abrasion members will rotatably pull the plant material up and out from the ground and, given the centrifugal force imparted by the rotation of the axle, the plant material will be projected outwardly in the direction of the rotation. In some embodiments, a deflector will capture the upwardly thrusted plant material allowing it to slide back down towards the ground, re-depositing the disturbed plant material on the ground as a mulch. This can provide the use of the disturbed weeds and other plant material as mulch, additional fertilizer, and nutrients to the ground as the plant material decomposes and shade other weed seeds from germination. Further, as the weed control apparatus is directed over a planted field, between each row of planted crops, it will disrupt any short, grass-like or newly forming binding weeds and then lay down mulch behind to slow down any re-growth.

While deflectors described herein are shown in the exemplary figures as somewhat semicircular, one of ordinary skill in the art will appreciate that a deflector may be more or less than semicircular, or may be shaped differently (e.g., square, rectangular, rounded rectangular cap, gabel-shaped, gambrel-shaped). Additional cutting implements (e.g., knives, blades, sharp filaments, and the like) may be provided either on an interior surface of a deflector and/or between and among abrasion members on an axle to complement the abrasion members described herein and assist in cutting or grinding weed plants into mulch.

In alternative embodiments, the weed control apparatus may also have injectors that can inject liquid or solid fertilizers into the chamber to aid crop growth in the same space in which weeds are removed. This allows the use of the invention to clean weeds from areas where the crop will be planted, coat the area with fertilizer or possibly inject fertilizer into the soil. This provides the ability to make a no-till, weed-free seed bed where the crop can be planted. However, the seed bed prepared according to this disclosure does not require tilling, strip till or minimum tilling. Hence, the invention enables a till-free seed bed preparation methodology.

According to embodiments of this disclosure, the robotic weed control apparatus may be used to control short grass-like weeds according to the following method. Before planting in spring, winter weeds (very low to the ground) and grasses that are attempting to start may be removed with the weed control apparatus. After remove of these winter weeds, the crop may be planted using a conventional approach. Once the crops are planted, grass and bindweed growth is controlled to remain within 1 inch of the crop by driving the weed control apparatus every 3-5 weeks while moisture is still plentiful, normally early in the season. As the season goes on and the crop begins to grow canopies that cover over the space between the crop rows, the application of the weed control can be less frequent given the impact of shade on the weed growth. One of ordinary skill in the art will realize that different crops, such as corn, milo, soybeans, hemp, cotton etc., may provide different shading with corresponding impact on weed growth. Thus, the frequency of weed removal may vary accordingly. Following this methodology, usage of herbicide organic crops of corn, milo, soybeans, hemp, cotton or the like may be reduced or eliminated. Moreover, weed resistance to herbicides is also overcome by the mechanical weed removal approach enabled by the disclosed methodology. In addition, the weed control apparatus according to this disclosure can operate regardless of weather conditions. For example, while the spraying of herbicides is limited to favorable weather conditions, the robotic weed control described herein can be deployed at any time. Further, embodiments of the weed control apparatus according to this disclosure are light enough that can be deployed even when the ground is too wet for other heavy equipment.

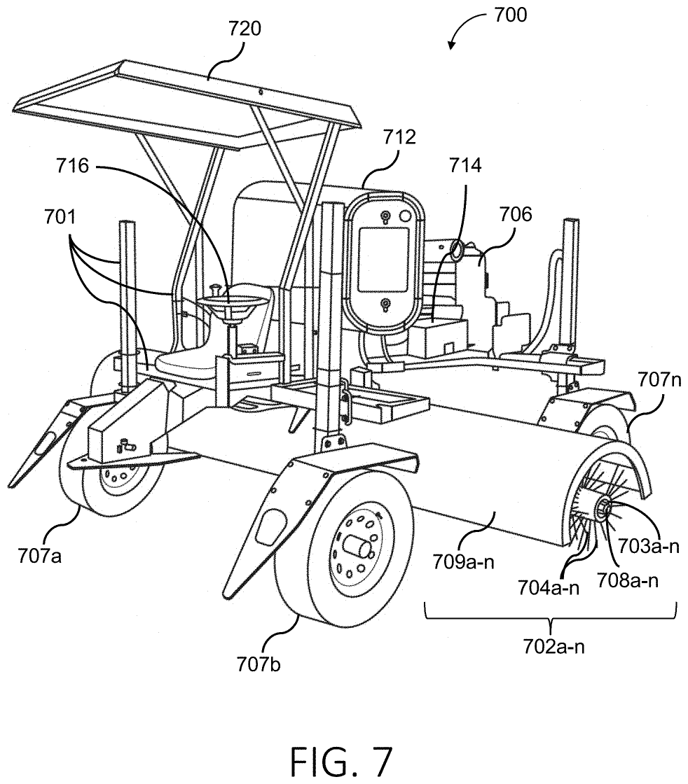

FIG. 7 illustrates still another exemplary weed control robotic apparatus according to one embodiment of the disclosure. The weed control robotic apparatus 700 may include a robotic chassis 701 and one or more end effector(s) 702a-n. Like-numbered and like-named elements may perform the same or similar functions as described elsewhere herein. For example, robotic chassis 701 may carry a drive train module 706 to provide mobility, including a plurality of wheels 707a-707n (not all are shown) driven by a motor (not shown), a power source 712, and a controller 714.

The end effector(s) 702a-n may include one or more rotary axle(s) 703a-n (not all shown) mechanically coupled to a drive unit (not shown) and one or more deflector(s) 709a-n (not all shown) that surrounds at least an upper section of end effector(s) 702a-n. The drive unit may include a motor, such as an electric motor, a gas engine, or the like. The drive unit may engage rotary axle(s) 703a-n through a drive shaft (not shown) to cause the rotary axle's rotation around its long axis, causing the outer ends of filaments 704a-n to make contact with the ground under the apparatus 700 to disturb vegetation and a top portion of soil under the end effector with minimal soil disturbance. Filaments 704a-n (or blades, chains, discs, and other forms, as described and shown herein) may be removably attached to a one or more core rods 708a-n that run(s) axially through the center of rotary axle(s) 703a-n, each core rod 708a-n corresponding to each rotary axle 703a-n. Each of rotary axle(s) 703a-n and its corresponding core rod 708a-n may be between 3 and 30 inches. As with systems 100 and 200, the system 700 may be controlled using a combination of machine vision combined with other control systems (e.g., GPS and/or Lidar combined with drone imaging or maps data to create 3D imaging).

In some embodiments, the drive train module 706 may include a motor to drive some or all of wheels 707a-n. In some embodiments, robotic system 700 also may include a steering wheel 716 to facilitate the handling of the system by human operators (e.g., to load or unload into a carrier vehicle, for testing, and the like). Power source 712 may include a battery, set of battery cells, or other means of providing power to drive train module 706 and end effector 702.

A controller 714 may also be included to provide control of the robotic apparatus 700, including maneuvering of the drive train module, battery management, end effector control, communications, and the like. As described herein, similar to controller 214 in FIG. 2, controller 714 may include a sensing module, a communications module, a memory module, and a processing module.

Although not shown in FIG. 7, a person of ordinary skill in the art would appreciate that while end effector(s) 702a-n is shown as a single end effector, it may comprise two or more end effectors configured end-to-end with a space in between in order to define two or more rows (e.g., planting rows). As end effector(s) 702a-n eliminate one or more rows of weeds, they may define one or more planting rows, the locations of which (e.g., as determined using GPS or other means of locating a row and/or path treated by system 700) may be recorded automatically by a controller and provided to a planting apparatus or system (e.g., a tractor and/or planter system), which may use such location data to plant along the one or more planting rows.

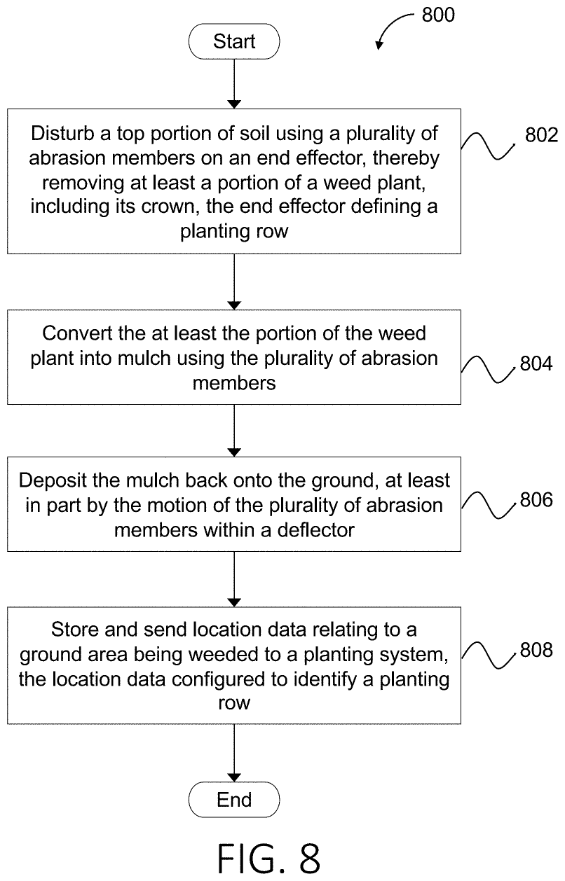

FIG. 8 is a flow diagram illustrating a method for robotic weed control, in accordance with one or more embodiments. Method 800 may begin with disturbing a top portion of soil using a plurality of abrasion members on an end effector, at step 802, thereby removing at least a portion of a weed plant, including its crown and/or stem. In some examples, the end effector may include a rotary axle and core rod from which the plurality of abrasion members may extend radially, and a deflector, as described herein. In some examples, the end effector may be sized to define a planting row (e.g., a length of the rotary axle and or core rod from which the plurality of abrasion members extend corresponding to a desired planting row width). At least a portion of the weed plant may be converted into mulch using the plurality of abrasion members at step 804. For example, the plurality of abrasion members may be configured to remove the weed plant, including its crown and/or stem, disturbing a minimal amount (e.g., 0.1-0.3 inches deep) of a top portion of soil, and to cut and/or grind the weed plant as the plurality of abrasion members rotate at least partially within a volume defined by an internal (i.e., under) surface of the deflector, thereby converting the weed plant to mulch. The mulch may be deposited back onto the ground at step 806, at least in part by the motion of the plurality of abrasion members within the deflector. In some examples, a surface of the deflector may be provided with cutting implements, as described herein, to assist with the conversion of the weed plant to mulch. Location data relating to a ground area being weeded (e.g., a weeded row) may be stored (e.g., in a memory) and sent (e.g., by a communications module) to a planting system at step 808, the location data configured to identify a planting row (e.g., a row that has been weeded and is ready for planting).

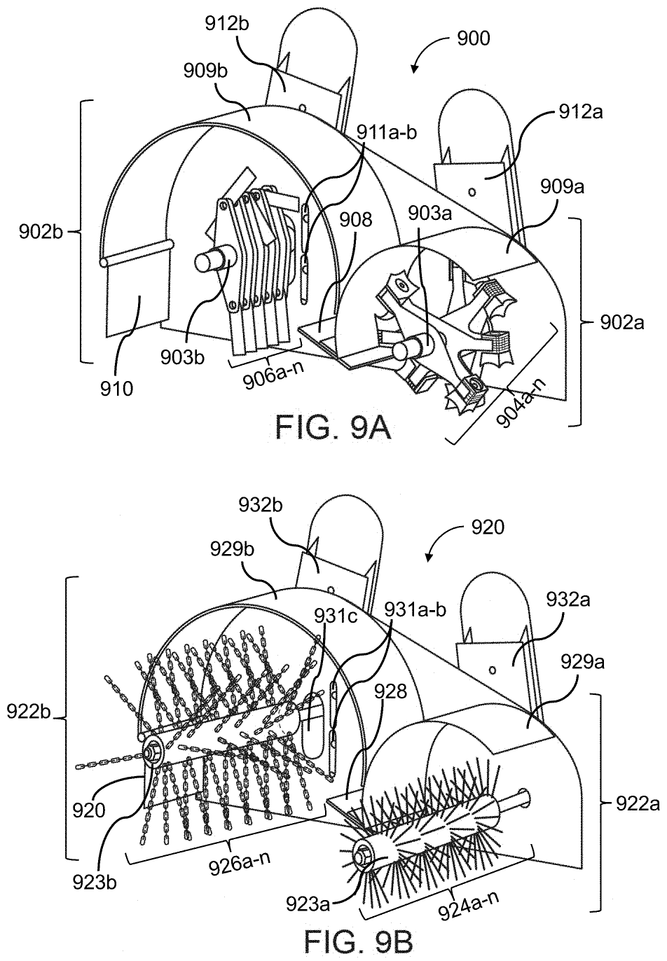

FIGS. 9A-9B are diagrams that illustrate perspective views of other exemplary end effectors for weed control robotic apparatus according to one or more embodiments of the disclosure. In FIG. 9A, end effector system 900 comprises end effectors 902a-b. In FIG. 9B, end effector system 920 comprises end effectors 922a-b. End effectors 902a-b may include rotary axles 903a-b, respectively. End effectors 922a-b may include rotary axles 923a-b, respectively. Rotary axles 903a-b and 923a-b may have a plurality of abrasion members removably coupled to them and extending radially from an outer surface. For example, rotary axle 903a may have abrasion members 904a-n removably coupled to, and extending radially from an outer surface of, rotary axle 903a, while rotary axle 903b may have abrasion members 906a-n removably coupled to, and extending radially from an outer surface of, rotary axle 903b. In another example, rotary axle 923a may have abrasion members 924a-n removably coupled to, and extending radially from an outer surface of, rotary axle 923a, while rotary axle 923b may have abrasion members 926a-n removably coupled to, and extending radially from an outer surface of, rotary axle 923b. Rotary axle 903a and abrasion members 904a-n may be partially covered by deflector 909a, wherein deflector 909a may surround or define at least an upper portion of end effector 902a. Similarly, rotary axle 903b and abrasion members 906a-n may be partially covered by deflector 909b, wherein deflector 909b may surround or define at least an upper portion of end effector 902b. Deflectors 929a-b may similarly surround or define at least an upper portion of end effectors 922a-b, respectively, thereby partially covering rotary axle 923a plus abrasion members 924a-n and rotary axle 923b plus abrasion members 926a-n, respectively.

In some examples, abrasion members 904a-n, 906a-n, 924a-n, and 926a-n may comprise filaments, chains, blades, discs, other cutting implements (e.g., as shown in FIGS. 3A-6C). In some examples, end effectors 902a and 922a may be located in front of end effectors 902b and 922b, respectively. In these examples, end effectors 902a and 922a may be configured to dislodge at least a portion (e.g., a crown, a stem, and/or other portion to terminate a plant) of unwanted plant material (e.g., a weed) from the ground. For example, rotary axles 903a and 923a may be coupled to a chassis at a height such that abrasion members 904a-n and 924a-n are caused to disturb approximately 0.125 to 0.25 inches, or other minimal amount, of a top layer of soil (e.g., no-till). In some examples, end effectors 902b and 922b may be configured to convert the largely dislodged unwanted plant material (e.g., by end effectors 902a and 922a) to mulch. For example, rotary axles 903b and 923b may be coupled to a chassis at a height such that abrasion members 906a-n and 926a-n may cut, churn, or otherwise break up the largely dislodged unwanted plant material and leave it, or place it back, on the ground.

In some examples, each of rotary axles 903a-b and 923a-b may be mechanically coupled to a drive unit (not shown), which may include a motor, such as an electric motor, a gas engine, or the like. In some examples, rotary axles 903a-b and 923a-b may be coupled to a drive unit by a core rod, as described herein. The drive unit may engage rotary axles 903a-b and 923a-b through a drive shaft (not shown) to cause the rotary axle's rotation around its long axis, causing the outer ends of abrasion members 904a-n, 924a-n, 906a-n, and 926a-n to make contact with the ground and/or unwanted plant material under a vehicle carrying end effectors 902a-b and 922a-b (e.g., systems 100, 200, and 700) to disturb vegetation and/or a minimal top portion of soil. In some examples, abrasion members 906a-n and 926a-n, configured to convert plant material to mulch, may be longer than abrasion members 904a-n and 924a-n, configured to dislodge at least a portion of unwanted plant material (e.g., a crown portion) from the ground. As with systems 100, 200, and 700, end effector systems 900 and 920 may be controlled using a combination of machine vision combined with other control systems (e.g., GPS and/or Lidar combined with drone imaging or maps data to create 3D imaging).

In some examples, end effectors 902a-b and 922a-b may be coupled to a chassis mechanically using one or more panels 912a-b and 932a-b. In some examples, rotary axles 903a-b and 923a-b may be height adjustable. In an example, panels 912b and 932b may be coupled to end effectors 902b and 922b, respectively, using slots or holes 911a-b and 931a-b, respectively. Slots or holes 911a-b and 931a-b may be configured to allow panels 912b and 932b to be coupled at various heights (e.g., using bolts or other mechanical coupling) with respect to end effectors 902b and 922b, respectively, in order to lift or lower rotary axles 903b and 923b. Additional slots or holes, not shown, may similarly allow height adjustment for rotary axles 903a and 923a. Those in the art will understand there are many different ways to implement a height adjustable axle that would work within systems 900 and 920.

In some examples, baffles 908 and 928 may be provided between end effectors 902a-b and 922a-b, respectively. Baffles 908 and 928 may be positioned to help keep dislodged portions of unwanted plant material on or close to the ground after being dislodged, end effectors 902a-b and 922a-b are being carried forward over that portion of ground by a vehicle, thereby preventing said unwanted plant material from returning back up through front end effectors 902a and 922a and leaving it to be processed into mulch by end effectors 902b and 922b. In example, baffles 908 and 928 each may be tilted such that a lower front edge protrudes into end effectors 902a and 922a, respectively, while a higher back edge protrudes into end effectors 902b and 922b, respectively. In some examples, baffle 908 may be coupled to one or both of deflectors 909a-b, and baffle 928 may be coupled to one or both of deflectors 929a-b. In other examples, baffles 908 and 928 may be coupled to other components of end effectors 902a-b and 922a-b (e.g., a side panel, other portions of a chassis or enclosure) instead of, or in addition to, deflectors 909a-b and 929a-b.

In some examples, abrasion members 904a-n and 924a-n may be rotated in a direction of travel by rotary axles 903a and 923a, respectively. In other examples, abrasion members 904a-n and 924a-n may be rotated against a direction of travel, and wherein baffles 908 and 928 are tilted so that there is a higher front edge protruding into end effectors 902a and 922a, respectively, and a lower back edge.

In some examples, flaps 910 and 920 may be hinged to a back edge or end of deflectors 909b and 929b, respectively. Flaps 910 and 920 may be configured to control the dispersion of mulch generated by end effectors 902b and 922b, respectively, including achieving a more even distribution of the mulch created by end effectors 909b and 929b, respectively, onto the ground. In some examples, flaps 910 and 920 may be hinged to allow flaps 910 and 920 to swing back and forth to create a dynamic discharge opening behind end effectors 902b and 922b, respectively. In other examples, flaps 910 and 920 may be fixed at a given angle to create a static discharge opening with a predetermined height. For example, flaps 910 and 920 may be hinged or fixed to create a smaller discharge opening to ensure mulch is dropped closer to where the unwanted plant material is processed. In another example, flaps 910 and 920 may be fixed to create a larger discharge opening, or removed altogether, to allow the mulch to be deposited over a wider area.

As with other end effectors described herein, end effector systems 900 and 920 may be configured to clear and prepare (e.g., by abrasion and mulching) rows of fields for planting, i.e., defining one or more planting rows. In some examples, the locations of rows defined by end effector systems 900 and 920 (e.g., as determined using GPS or other means of locating a row and/or path treated by systems 900 and 920) may be recorded automatically by a controller and provided to a planting apparatus or system (e.g., a tractor and/or planter system), which may use such location data to plant along the one or more planting rows defined by systems 900 and 920. In other examples, a planting apparatus or system may be driven (e g, manually, remotely, or autonomously) behind a vehicle comprising end effector systems 900 and/or 920 to plant in planting rows defined and prepared by end effector systems 900 and/or 920. In still other examples, end effector systems 900 and 920 also may be configured to perform the abrasion and mulching described herein between existing or planned crop rows.

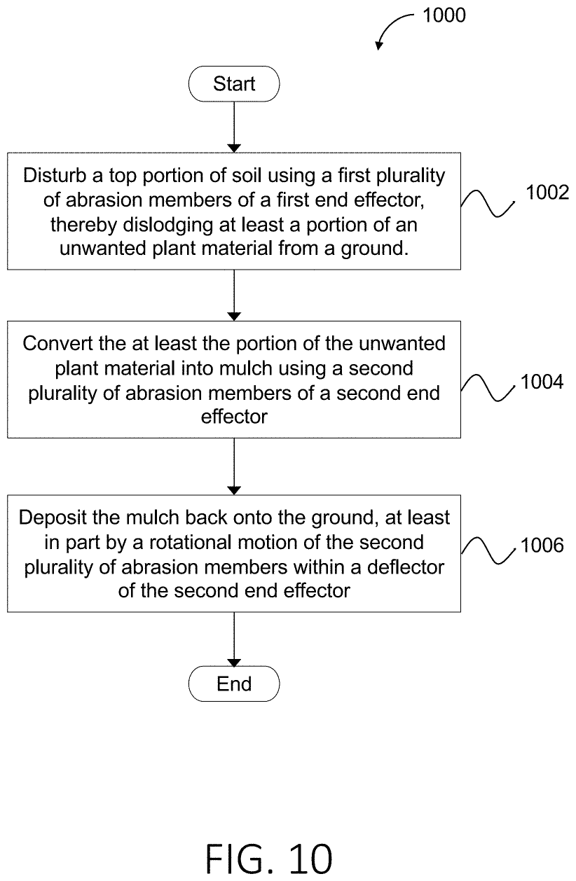

FIG. 10 is a flow diagram illustrating another method for robotic weed control, in accordance with one or more embodiments of the disclosure. In process 1000, a top portion of soil is disturbed using a first plurality of abrasion members of a first end effector, at step 1002, thereby dislodging at least a portion of an unwanted plant material from a ground. As described herein, the top portion of soil may be a minimal amount (e.g., approximately 0.125 to 0.25 inches, or other minimal amount, of a top layer of soil that is no-till compliant), and the portion of the unwanted plant material that is removed may include at least a crown. In step 1004, the at least the portion of the unwanted plant material is converted into mulch using a second plurality of abrasion members of a second end effector. As shown in FIG. 9, the first end effector may be coupled to a chassis in a forward position with the second end effector behind it, relative to a direction of travel of the chassis (e.g., of a vehicle). The mulch (e.g., converted by the second plurality of abrasion members) may be deposited back onto the ground, at least in part by a rotational motion of the second plurality of abrasion members within a deflector of the second end effector, at step 1006. As described herein, the portion of the unwanted plant material may be deposited back onto the ground after being dislodged from the ground by the first end effector with the aid of a baffle extending at least partially into the first end effector. In some examples, the baffle also may extend partially into the second end effector, a back edge of the baffle extending into the second end effector being higher than a front edge of the baffle extending into the first end effector. As described herein the first end effector and the second end effector each may comprise a deflector covering (e.g., enclosing) at least an upper portion of the first and the second plurality of abrasion members. In some examples, a hinged flap may be coupled to a back edge of the second end effector, as described herein.

As those in the art will understand, a number of variations may be made in the disclosed embodiments, all without departing from the scope of the invention, which is defined solely by the appended claims. It should be noted that although the features and elements are described in particular combinations, each feature or element can be used alone without the other features and elements or in various combinations with or without other features and elements.

What is claimed is:

1. An apparatus for control of unwanted plant material comprising:
a chassis; and
two or more end effectors mechanically coupled to the chassis, the two or more end effectors including a first end effector comprising a first rotary axle and a second end effector comprising a second rotary axle, each of the first and second rotary axles coupled to a drive unit for receiving a mechanical force to cause the rotary axle to rotate,
wherein the first end effector comprises a first deflector at least partially covering the first rotary axle and a first plurality of weed abrasion members removably coupled to the first rotary axle in a first radial pattern, and
wherein the second end effector comprises a second deflector at least partially covering the second rotary axle and a second plurality of weed abrasion members removably coupled to the second rotary axle in a second radial pattern.

2. The apparatus of claim 1, wherein the first end effector is configured to dislodge one or both of a crown portion and a stem portion of the unwanted plant material from the ground.

3. The apparatus of claim 1, wherein the second end effector is configured to convert at least some of the unwanted plant material into mulch.

4. The apparatus of claim 1, further comprising a baffle comprising a front edge extending into the first end effector.

5. The apparatus of claim 4, wherein the baffle further comprises a back edge positioned higher than the front edge.

6. The apparatus of claim 1, further comprising a hinged flap coupled to a back end of the second deflector.

7. The apparatus of claim 1, wherein one or both of the first and the second rotary axles are height adjustable.

8. The apparatus of claim 1, wherein one or both of the first and second plurality of weed abrasion members comprise(s) a filament, a chain, a blade, or a disc.

9. The apparatus of claim 1, wherein the first plurality of weed abrasion members comprises a different form than the second plurality of weed abrasion members.

10. The apparatus of claim 1, wherein the first end effector is coupled to the chassis at a height such that the first plurality of weed abrasion members are caused to disturb between 0.125 and 0.25 inches of a top layer of soil when the first rotary axle is turning.

11. The apparatus of claim 1, wherein the second plurality of weed abrasion members are longer than the first plurality of weed abrasion members.

12. The apparatus of claim 1, wherein the chassis is constructed of one, or a combination, of aluminum, steel, and carbon fiber.

13. The apparatus of claim 1, wherein the chassis is configured to carry the drive unit.

14. The apparatus of claim 1, wherein the chassis is configured to carry a power source.

15. The apparatus of claim 1, further comprising a controller configured to provide control of one or more components of the chassis and/or the end effector.

16. The apparatus of claim 15, wherein the one or more components includes one, or a combination, of a drive train module, a power source, and the end effector.

17. The apparatus of claim 15, wherein the controller includes a sensing module configured to process data from one or more sensors.

18. A method, comprising:
disturbing a top portion of soil using a first plurality of abrasion members of a first end effector, thereby dislodging at least a portion of an unwanted plant material from a ground;
converting the at least the portion of the unwanted plant material into mulch using a second plurality of abrasion members of a second end effector; and
depositing the mulch back onto the ground, at least in part by a rotational motion of the second plurality of abrasion members within a deflector of the second end effector.

19. The method of claim 18, wherein the at least a portion of the unwanted plant material comprises one or both of a crown portion and a stem portion of the unwanted plant material.

20. The method of claim 18, further comprising depositing the portion of the unwanted plant material back onto the ground after dislodging the at least the portion of the unwanted plant material from the ground with the aid of a baffle comprising a front edge extending into the first end effector.

21. The method of claim 18, wherein the first end effector is positioned in front of the second end effector relative to a forward motion of a chassis to which the first and the second end effectors are coupled.

22. The method of claim 18, wherein the top portion of soil comprises between 0.125 and 0.25 inches of a top layer of the soil.

23. The method of claim 18, wherein the disturbing the top portion of soil is no-till compliant.
